(19) United States
(12) Patent Application Publication
(10) Pub. No.: US 2023/0214849 A1
(43) Pub. Date: Jul. 6, 2023

(54) Landscape Carbon Calculator

(71) Applicant: Richard L Taylor, Sebastopol, CA (US)

(72) Inventor: Richard L Taylor, Sebastopol, CA (US)

(21) Appl. No.: 18/146,701

(22) Filed: Dec. 27, 2022

Related U.S. Application Data
(60) Provisional application No. 63/266,308, filed on Dec. 31, 2021.

(51) Int. Cl. G06Q 30/018; G06Q 50/08

(52) U.S. Cl. CPC G06Q 30/018; G06Q 50/08

(57) ABSTRACT

A landscape carbon calculator system including a downloadable web application user interface for installation on network connectable devices, and a server computer programmed with computer-readable and computer-usable and executable code stored in a tangible medium to be accessible by users through the web application. The server computer is programmed with executable code and is configured to calculate the estimated carbon emissions associated with the construction of a landscape design and how long the proposed design will take to sequester the carbon emitted to build the design, thereby enabling users to determine the ecological impact of a landscape design and/or build prior to construction and to assess actual vs. projected emissions used during and after construction.

### CROSS REFERENCES TO RELATED APPLICATIONS

The present application claims the benefit of the filing date of U.S. Provisional Pat. Application Serial No. 63/266,308, filed Dec. 31, 2021 (Dec. 31, 2021), which application is incorporated in its entirety by reference herein.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### SEQUENCE LISTING

Not applicable.

### BACKGROUND OF THE INVENTION

Field of the Invention: The present invention relates most generally to carbon emission and sequestration calculators, and more particularly to carbon emission and sequestration calculators for use in various kinds of construction projects, and still more particularly to a carbon emission and sequestration calculator for provider landscaper designers to closely estimate carbon emissions and carbon sequestration involved in a proposed landscape design and to identify and evaluate optimal leverage points for improving the design to meet environmental goals. The invention finds practical application in residential, commercial, and municipal landscape design, architecture, and construction, as well as municipal, state, and federal carbon monitoring and enforcement and global carbon credit tracking and enforcement.

Background Discussion: Carbon emissions calculators are known. Several bear some similarities to the present invention insofar as they provide means for calculating carbon emissions or sequestration based on data entered by the user. Some include both. None, however, involve the use of calculator that provides data at the level of specificity required for practical decision-making for environmentally concerned designers who wish to develop beautiful projects that balance the inevitable carbon footprint with responsible environmental stewardship.

### BRIEF SUMMARY OF THE INVENTION

In embodiments, the present invention is implemented in a networked computer infrastructure providing cloud-based software services to end users accessing the system through a user interface operating on a network connectable device. System servers having executable code operate to provide a landscape carbon calculator through which users input data relating to a landscape design proposed for a project to understand and assess the carbon footprint related to the project. As a tool, the invention enables users to consider “leverage points”, or those aspects of the proposed project most amenable to improvement through the use of substitute materials or means of construction.

The present invention considers and evaluates multiple construction elements into a single calculation that significantly simplifies a user’s experience. For instance, in calculating the carbon emissions in a landscape design, the present invention combines calculations for masonry walls, transportation of materials to the jobsite, flatwork, deliveries, and so on). The system analyzes sequestration data and uses equations that account for shortened landscape lifespan due to changing climate conditions, while separating out plant phytotypes. As another example, the inventive landscape carbon calculator employs algorithms that combine the carbon footprints of steel, concrete, and stone aggregate materials into a formula that allows the end user to simply input the linear feet of wall and receive an approximate carbon footprint, rather than having to calculate each individual item.

The landscape carbon calculator of the present invention calculates the estimated carbon emissions associated with the construction of landscapes and how long the proposed design will take to sequester the carbon emitted to build it. Landscape design-and-build professionals use this to determine the ecological impact of their design and/or build. It is used to inform designers of the impacts prior to construction and is used during and post-construction to assess actual vs. projected emissions.

The landscape carbon calculator (alternatively and variably referred to herein as the “LCC”) was developed as a tool to solve the problem of calculating detailed carbon emissions and sequestrations throughout the landscape design and build processes. The application provides detailed data, at the component level, of the emissions associated with landscape construction and maintenance. In addition, it calculates the different types of sequestration based on plant and soils choices and creates both initial and annual rates of sequestration. The combined calculated data of these three groups; emissions, initial sequestration, and annual sequestration is then projected into a graph representing the “sequestration equilibrium timeline” (variably referred to herein as the “SET”), which is the number of years a proposed landscape design will take to sequester the emissions required to build it. A secondary calculator allows users to enter the number of years they may wish it to take and also calculates the additional annual sequestration and the emission reduction needed to meet the desired timeline.

Data is presented visually to the user in six formats: Numerical lists in the inputs categories, bar charts, pie charts, and a horizontal slide chart.

All charts other than the numerical lists are exportable for the user to build customized reports in an application of choice.

The calculator organizes publicly available data on carbon footprints and plant sequestration rates into a user interface with approximately 300 data entry points and produces itemized and downloadable reports, and graphs of the approximate carbon footprint as well as the sequestration timeline itemized by relevant sequestration components.

The end user accesses the product through a subscription based, software-enabled website.

It is therefore an object of the present invention to provide a new and improved landscape carbon calculator to provide data points regarding optimal places in a landscape design to introduce solutions that reduce carbon emissions and increase carbon sequestration. The data identifying and highlighting those leverage points educate the design and build industries and enable professionals to make optimal adjustments to plans to fulfill client interests while implementing responsible plans.

It is another object of the present invention to provide a new and improved landscape carbon calculator that organizes publicly available data on carbon footprints and plant sequestration rates into a user interface with approximately 300 data entry points and produces itemized and downloadable reports and graphs of the approximate carbon footprint as well as the sequestration timeline itemized by relevant sequestration components. An end user accesses the product (i.e., a visual presentation of data) through a subscription based, software-enabled website.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention which will form the subject matter of the claims to be presented in a non-provisional patent application claiming the benefit of the instant application.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is high level schematic flow chart following system features and functions from a user’s first inputs relating to a landscape design through system calculations to report generation and export;

FIG. 2 is a schematic flow chart showing exemplary system architecture for implementing the landscape carbon calculator;

FIG. 3 is a flow chart showing the emissions and sequestration calculations and reports generated from user input in an embodiment of the invention; and

FIG. 4 is a flow chart showing an “Improve Your Project” feature that enables users to identify leverage points for design improvement in the form of reduced carbon emissions and increased carbon sequestration.

### DETAILED DESCRIPTION OF THE INVENTION

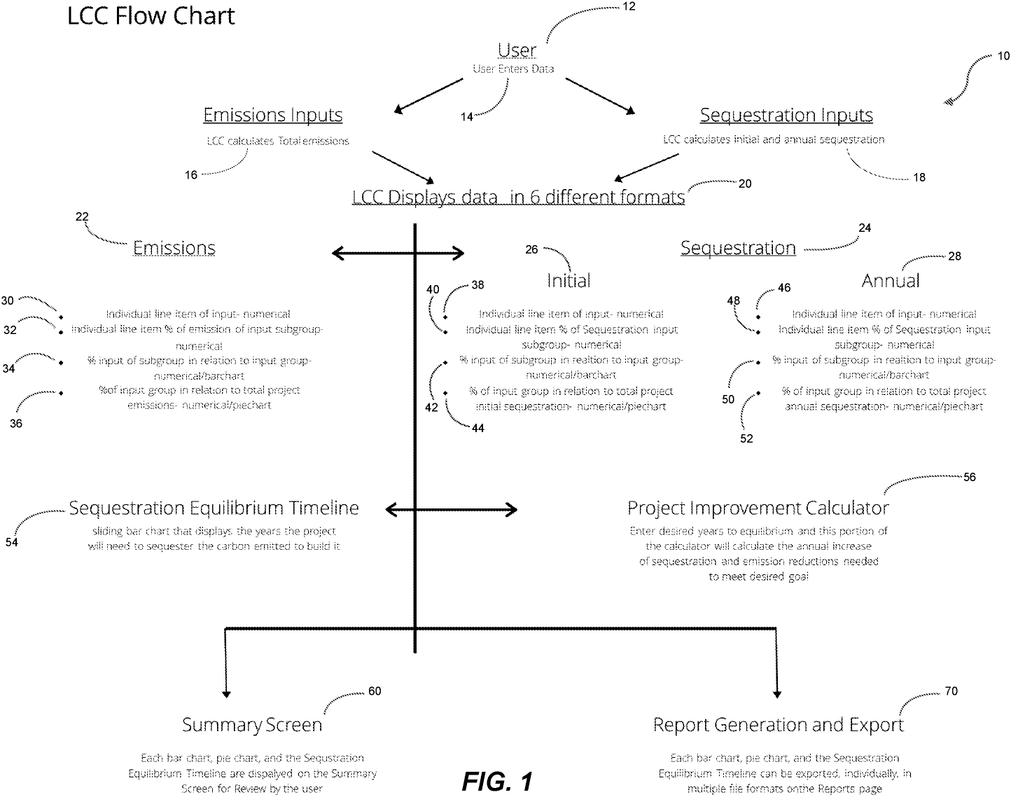

Referring to FIGS. 1 through 4, wherein like reference numerals refer to like components in the various views, there is illustrated therein a new and improved landscape carbon calculator, generally denominated 10 herein.

FIG. 1 summarily shows the flow of information from data input to report output. This chart assumes that a user has already downloaded an application interface and has a network connectable device for accessing the LCC system through a user interface on that device. In that vein, to commence use of the system, 10, the user 12 will create a project and select that project from a Projects Page, naming and dating the project start date. When clicked on, the project will open to an “inputs page.” Here the user will begin to enter data 14 relating to the project. If it is a new project, on the inputs page the user will input data not previously entered, selecting categories (“input groups”) into which information may be provided, including, among other things, information about: (1) Hardscape, such as walls, wall veneers/and stone type, mortared flatwork, sand set/dry lay flatwork, dry stack walls, edging, and additional hardscape materials; (2) Grading and land clearing; (3) Drainage, including drainage components, such as pipe, aggregates; (4) Irrigation and greywater, including irrigation piping, irrigation infrastructure components, and drip irrigation; (5) Rain catchment, including tanks, plumbing, and pumps; (6) Lighting, including fixtures and infrastructure; (7) Water features, including infrastructure, stone, and plants; (8) Plant Material; (9) Soil and mulch; (10 Decking, including virgin and recycled plastic materials and/or woods (11) Transportation, including project constants, daily construction trucks, project manager and/or owner travel mileage, and initial material runs; (12) Deliveries, categorized by type, viz., Category 1 Small Truck and Category 2 Large Diesel (6-wheel or larger); (13) Equipment used on the job site, including large equipment and small equipment; and (14) Sequestration features, such as shrubs, perennials, grasses, and trees.

With the data for each applicable input group entered, the LCC will calculate total carbon emissions for the project 16, as well as the initial and annual sequestration 18 effected by the plant materials identified, and it will then display the calculated data in multiple formats 20.

The user may then elect to review the carbon footprint data for the project from a summary page 60 by clicking on a Summary Page tab or button, whereupon the Summary Page opens and the user is presented with visual and numerical information indicating the calculated emissions 22 and the calculated sequestration 24, including the initial sequestration 26 and annual sequestration 28. In an embodiment, this may include a combination of numerically represented data and graphically represented data, the latter in the form of donut charts, bar graphs, and pie charts.

Substantively, and with respect first to the calculated emissions 22, in embodiments the report includes an individual numerical line item of input 30, an individual line item percentage of emission of input as a subgroup 32, a numerical percent and bar chart representation of the input of the subgroup in relation to the input group 34, and a numerical and pie chart graph showing the percent of the input group in relation to the total project emissions 36.

With respect to the calculated initial carbon sequestration 26, in embodiments the report includes an individual numerical line item of input 38, an individual line item percentage of sequestration input as a subgroup 40, a numerical percent and bar chart representation of the input of the subgroup in relation to the input group 42, and a numerical and pie chart graph showing the percent of the input group in relation to the total project initial sequestration 44.

The Summary Page 60 also presents the user with a singular horizontal slider graph, known as the Sequestration Equilibrium Timeline 54 (or SET). This graphical representation shows the user in a sliding bar chart format the number of years the project will require to sequester the carbon emitted in building the project.

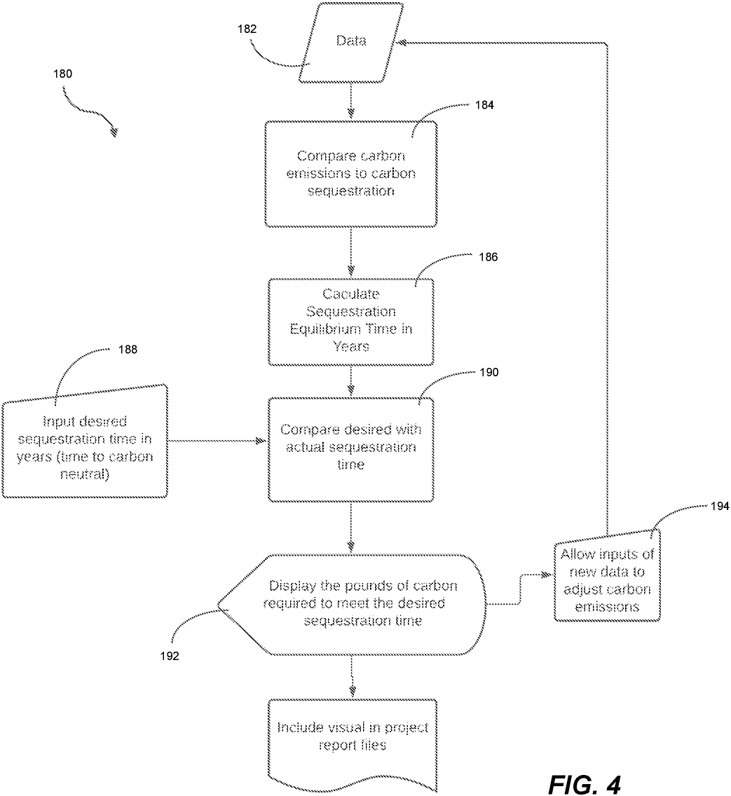

If the user so wishes, the Summary Page provides the user with an option to explore and consider possible project improvements using an “Improve Your Project” Calculator 56. This enables the user to enter the years he/she would hope to have sequestration equilibrium reached in the project, and the program will automatically calculate the annual increase in sequestration and reduction in emissions needed to meet the stated goal. This enables users to identify the largest carbon emission aspects of the project and to correct, as possible and as desired, while also enabling them to identify and optimize carbon sequestration by providing an overview of the entire landscape system and to make more informed plant material selections, plant diversity choices to increase productivity and resilience, and even to consider belowground carbon dynamics through soil management and selections. Further detail on this feature is discussed in connection with FIG. 4.

In embodiments, the user can hover over each section of the donut charts and the bar graphs with an input cursor, and the program will provide additional, more detailed information. The user may next export a project report 70 by clicking on a “Report” tab. The reports page opens and provides the user with option to select particular charts and files type they wish to export. The user may select and export one chart at a time or assemble a customized report in a third-party program of choice.

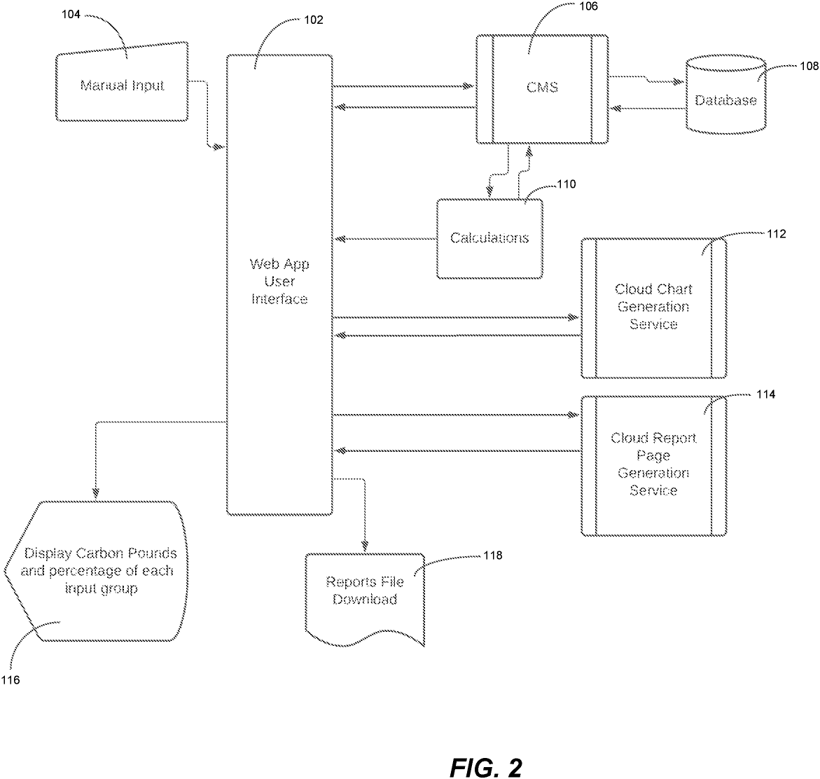

FIG. 2 shows a possible computer-implemented network architecture 100 through which system services may be provided to landscape designers as end users in certain embodiments. Those with skill will appreciate the many hardware/software/network options available to configure the system, but in embodiments common to contemporary data processing via the internet in a global computer network infrastructure, a user acts through a web application user interface (UI) 102 installed and executed on a network connectable devices, such as a desktop computer, laptop, tablet, or smart phone. The user makes manual inputs 104 through the UI to access and interact with the inventive landscape carbon calculator operating on server computers, either on-site or in the cloud, which are programmed with computer-readable and computer-usable and executable code stored in a tangible medium, such as electronic, magnetic, optical, or the like.

The LCC system includes a content management system 106, memory and a database 108, and a cloud-based processor which uses the user input to execute algorithms that calculate 110 carbon emissions and carbon sequestration and generates charts 112 and reports 114, and manages the output through the UI to display detailed reports 116 as described above. The system enables users to download a reports file for review without having to access the system online.

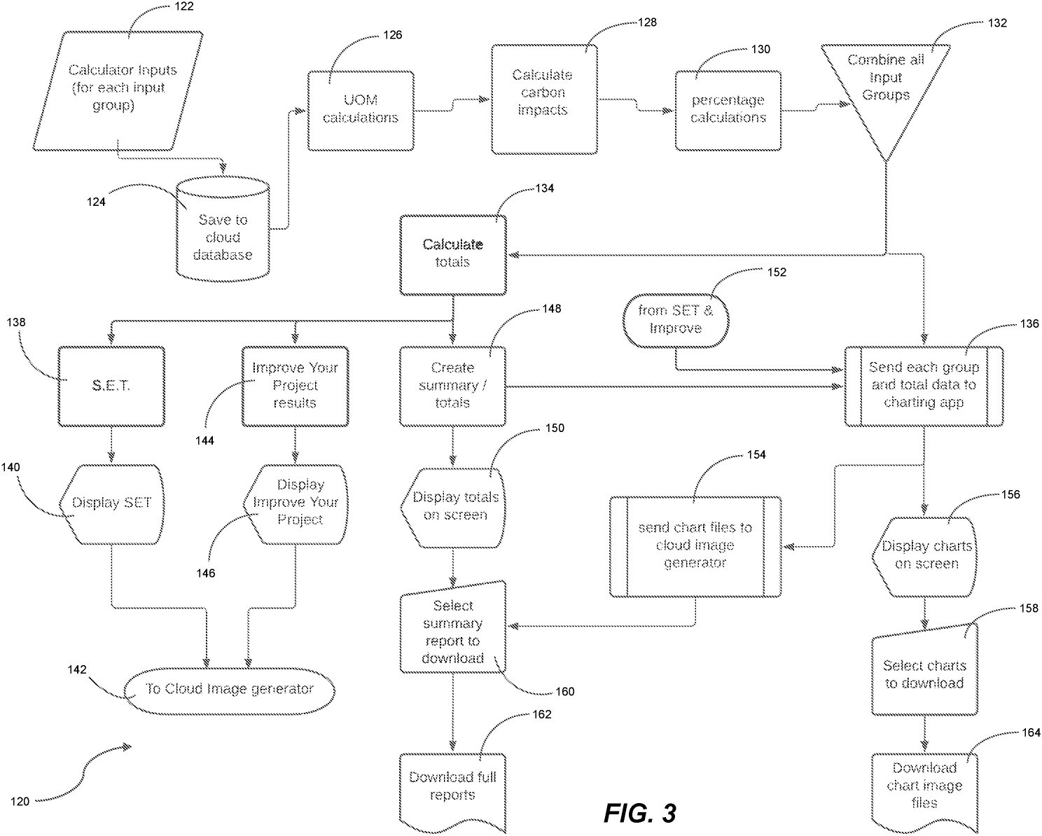

Referring now to FIG. 3, there is shown a flow chart 120 of the processing steps that may be performed by the LCC in some embodiments. As will be appreciated by those with skill, each recited step illustrated in a process block may constitute routines and subroutines of code packaged in modules or other combinations of executable instructions for carrying out the calculations.

At step 122 the user inputs data for each input group through the above-described UI. The data is communicated to the cloud-based database where it is stored at step 124. The system may execute uncertainty of measurement calculations at step 126 before passing the data on to the carbon impact calculation step 128.

Once the carbon impact has been calculated, the output is forwarded for calculation of input group percentage calculations at block 130. With those calculated, the system combines all input groups 132 and calculates the emissions and sequestration totals 134 while also sending each input group and total data to a charting application 136.

From the calculated totals step 134, the output may be forwarded to calculate the sequestration equilibrium timeline 138 and its depiction in a graphical display (horizontal sliding bar) 140, after which it is passed to a cloud-based image generator 142.

If the user elects to adjust the SET through the Improve Your Project (“IYP”) option, the system will also calculate 144 and then display 146 results based on the decreased SET time period selected by the user. Again, the calculated result is passed to the cloud-based image generator.

For purposes of presenting information in a summary form, the results calculated at step 134 are also created 148 and displayed 150, and the information from the summary totals 148, the SET and the IYP 152 are passed to the charting application 136. From there, the chart files are sent 154 to the cloud-based and may be displayed on the user’s screen 156. The user may then select charts to download 158, as well as the summary report to download 160, and the reports and charts are downloaded, 162 and 164, respectively.

FIG. 4 is an exemplary flowchart 180 showing IYP processing steps in certain embodiments. Here it is seen that the group input data 182, is employed to make a comparison 184 between carbon emissions entailed in the construction of a landscape project with the carbon sequestration achieved by a planting and soil management scheme. The comparison enables the program to calculate the SET in years 186 and to display the SET to the user (if so chosen).

If the user wishes to employ the IYP process, a desired SET timeline is input by the user 188, and the system then compares the desired SET with the SET from the initial design plan 190. The system will then display both emission reductions and sequestration increases needed to meet the desired SET. With that in hand, the user may input further, new data, to adjust carbon emissions and sequestration 194, at which time the data is looped back to the beginning of the process 182.

When the IYP process is complete, a graphic representation is included in the project report files 196 for the user the consult.

From the foregoing, it can be seen that in its most essential aspect, the present invention is a landscape carbon calculator system including a downloadable web application user interface for installation on network connectable devices, and a server computer programmed with computer-readable and computer-usable and executable code stored in a tangible medium to be accessible by users through the web application. The server computer is programmed with executable code and is configured to calculate the estimated carbon emissions associated with the construction of a landscape design and how long the proposed design will take to sequester the carbon emitted to build the design, thereby enabling users to determine the ecological impact of a landscape design and/or build prior to construction and to assess actual vs. projected emissions used during and after construction.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A landscape carbon calculator system, comprising:
a downloadable web application user interface for installation on network connectable devices; and
a server computer programmed with computer-readable and computer-usable and executable code stored in a tangible medium to be accessible by users through said web application;
wherein said executable code is configured to calculate the estimated carbon emissions associated with the construction of landscape designs and how long the proposed landscape design will take to sequester the carbon emitted to build the landscape design, thereby enabling users to determine the ecological impact of a landscape design and/or build prior to construction and to assess actual vs. projected emissions used during and after construction.

2. The landscape carbon calculator system of claim 1, wherein said server computer includes a content management system, memory, a database, and a cloud-based processor which uses user input provided through said web application user interface to execute algorithms that calculate carbon emissions and carbon sequestration, generates charts and reports, and manages the data output through said user interface to display detailed reports.

3. The landscape carbon calculator system of claim 1, wherein said landscape carbon calculator system enables users to download reports files without having to access said server computer.

4. The landscape carbon calculator system of claim 1, wherein said landscape carbon calculator is configured to combine calculations for masonry walls, transportation of materials to landscape jobsite, flatwork, and deliveries, and to analyze sequestration data and use algorithms that account for shortened landscape lifespan due to changing climate conditions.

5. The landscape carbon calculator system of claim 1, wherein said landscape carbon calculator employs algorithms that combine the carbon footprints of steel, concrete, and stone aggregate materials into a formula that allows the end user to input the total linear feet of wall and to receive an approximate carbon footprint, thereby obviating the need to calculate each individual item.

6. The landscape carbon calculator system of claim 1, wherein said server computer is programmed and configured to provide detailed data of the emissions associated with landscape construction and maintenance at the level of the landscape components and to calculate the different types of sequestration based on plant and soils choices and with the output of such calculations to create both initial and annual rates of carbon sequestration.

7. The landscape carbon calculator system of claim 1, wherein said server computer is programmed and configured to use the combined calculated data of emissions, initial sequestration, and annual sequestration, and to project the date into a graph representing a sequestration equilibrium timeline or “SET” which shows the number of years a proposed landscape design will take to sequester the carbon emissions required to build it.

8. The landscape carbon calculator system of claim 1, further wherein said server computer is programmed and configured to enable users through said user interface to enter the desired timeline in years they wish a proposed landscape design to take to sequester the carbon emissions required to build it and calculate the additional annual sequestration and the emission reduction needed to meet the desired timeline.

9. The landscape carbon calculator system of claim 1, wherein a user inputs data from various input groups relating to a landscape project through an inputs page on said user interface, the data input groups consisting of: hardscape materials and dimensions; the scope of grading and land clearing actions; drainage components and dimensions; irrigation and greywater infrastructure components and dimensions; rain catchment components; lighting fixtures and infrastructure; water feature infrastructure and plants; plant material; soils and mulches; decking materials and dimensions; total transportation required for the project; deliveries by transport type; equipment used on the job site; and sequestration features.

10. The landscape carbon calculator system of claim 9, wherein the data for each applicable input group entered, said landscape carbon calculator calculates total carbon emissions for the landscape project and the initial and annual sequestration effected by any plant materials identified, and then displays the calculated data in multiple visual formats.

11. The landscape carbon calculator system of claim 10, wherein said visual formats for displaying calculated data include discrete and combined numerically represented data and graphically represented data.

12. The landscape carbon calculator system of claim 11, wherein said graphically represented data includes donut charts, bar graphs, and pie charts.

13. The landscape carbon calculator system of claim 12, wherein said calculated initial carbon sequestration is visually displayed in a discrete numerical line item of input, an individual line item percentage of sequestration input as a subgroup, a numerical percent and bar chart representation of the input of the subgroup in relation to the input group, and a numerical and pie chart graph showing the percent of the input group in relation to the total project initial sequestration.

14. The landscape carbon calculator system of claim 10, wherein the user is presented with a summary page having a sequestration equilibrium timeline (“SET”) presented in a single horizontal slider graph showing the number of years the landscape project will require to sequester the carbon emitted in building the project.

15. The landscape carbon calculator system of claim 14, wherein said server computer is programmed and configured to display on a summary page an “Improve Your Project” (IYP) calculator enabling the user to selectively investigate possible project improvements.

16. The landscape carbon calculator system of claim 15, wherein said IYP calculator enables the user to enter the years he/she desires to have sequestration equilibrium reached in the project, and said landscape carbon calculator calculates the annual increase in sequestration and reduction in emissions needed to meet the stated goal.

17. The landscape carbon calculator system of claim 16, wherein said IYP calculator enables users to identify the largest carbon emission aspects of the landscape project and to correct and optimize carbon sequestration by providing an overview of the entire landscape system, different plant material and plant diversity selections, and options for soil management and soil selections.
